(19) United States
(12) Patent Application Publication
(10) Pub. No.: US 2026/0270375 A1
(43) Pub. Date: Sep. 10, 2026

(54) ABNORMAL EVENT IDENTIFICATION AND WARNING METHOD, AND SYSTEM THEREFOR

(71) Applicant: FAR EASTONE TELECOMMUNICATIONS CO., LTD., Taipei City (TW)

(72) Inventors: HUAI-KUEI WU, New Taipei City (TW); CHUN-CHIEH KUO, New Taipei City (TW); HUA-PEI CHIANG, Taipei City (TW); CHYI-DAR JANG, Taipei City (TW); CHE-YU LIAO, Taipei City (TW); CHI-HUNG LIN, New Taipei City (TW); HUEI-SAN LIN, New Taipei City (TW); CHIH-WEI CHIEN, New Taipei City (TW); HUNG CHANG TSAI, Taipei City (TW); WEN CHIN CHANG, Taipei City (TW); PAO CHUAN CHEN, Taipei City (TW); I-TING LING, Taipei City (TW); SYUAN-PEI CHANG, Taipei City (TW); Tzuu-Yaw Lu, Taipei City (TW); Yi-Ren Wang, Taipei City (TW)

(21) Appl. No.: 19/435,584

(22) Filed: Dec. 29, 2025

Related U.S. Application Data
(60) Provisional application No. 63/768,236, filed on Mar. 7, 2025.

(51) Int. Cl. H04N 7/18; H04N 23/66; H04N 23/695

(52) U.S. Cl. CPC H04N 7/188; H04N 7/181; H04N 23/66; H04N 23/695

(57) ABSTRACT

The invention relates to an abnormal event identification and warning method and a system therefor. A plurality of audio acquisition devices receive environmental audio signals and perform sound recognition within partially overlapping effective pickup ranges. When at least two devices simultaneously detect an abnormal event sound, a main processor generates corresponding abnormal location information and transmits it to a camera device, which automatically adjusts its shooting view and focus based on the location information to generate an abnormal event image, thereby achieving multi-point sound source localization and real-time visual evidence acquisition.

This application claims priority for the U.S. provisional patent application No. 63/768,236 filed on 7 Mar. 2025, the content of which is incorporated by reference in their entirety.

### BACKGROUND OF THE INVENTION

### Field of the Invention

The invention relates to a smart monitoring technology that combines sound recognition and image tracking, in particular, to an abnormal event identification and warning method and a system thereof in multi-point distributed environments, which uses audio acquisition devices to identify abnormal events and guides camera devices to collect audio and image evidences and issue alerts.

### Description of the Prior Art

Currently, common environmental monitoring and safety warning systems are often used in forest reserves, construction sites, mining areas, or border patrols to identify abnormal sounds (such as explosions, machinery operation, chainsaws, or human intrusion). Such systems are mostly based on single-point sound sensors or surveillance cameras. When a specific sound source appears in a monitored region, the system will record or send an alarm signal.

However, existing sound monitoring systems mostly use fixed sampling or long-term recording methods, which can easily lead to data redundancy and power consumption. Furthermore, a single sensor cannot effectively determine the location or direction of the sound source, resulting in a lack of spatial positioning accuracy in alarm information. In addition, when the system needs to be deployed in mountainous areas, forests, or environments with unstable wireless signals, the reliability of data transmission and continuous monitoring is also greatly reduced.

To improve accuracy in monitoring, some technologies propose using multi-microphone arrays to estimate the direction of sound sources. However, such methods usually require high computing resources or explicit time synchronization mechanisms, making them difficult to apply in low-power, distributed monitoring environments. On the other hand, if the sound sensing results need to be combined with the imaging device, most traditional systems still have to rely on human intervention, which leads to a delay in response time and makes it impossible to guide the camera or on-site warning device to respond dynamically in real time.

Therefore, in the prior art, how to balance the accuracy of sound and image recognition, system energy consumption control, and real-time alert response in areas with limited resources or unstable communication environments remains an unsolved problem.

### BRIEF SUMMARY OF THE INVENTION

The invention provides an abnormal event identification method, which includes: receiving an environmental audio signal from a plurality of audio acquisition devices, wherein effective pickup ranges of the audio acquisition devices at least partially overlap; identifying whether the environmental audio signal comprises an abnormal event audio signal; generating an abnormal location information based on at least two environmental audio signals that simultaneously contain the abnormal event audio; transmitting the abnormal location information to at least one camera device; controlling at least one of the camera devices to adjust a shooting view and to focus based on the abnormal location information; and controlling at least one of the camera devices to shoot an image of an abnormal event and generating an abnormal event image.

The method further includes, before a main processor receives the environmental audio signals, steps of: comparing in real time whether the environmental audio signal contains an abnormal sound of the abnormal event audio through a slave processor configured for each of the audio acquisition devices; transmitting, by the slave processor, the environmental audio signal to the main processor when the environmental audio signal contains the abnormal sound; not transmitting, by the slave processor, the environmental audio signal to the main processor when the environmental audio signal does not contain the abnormal sound.

The invention further provides an abnormal event identification system, which includes: a plurality of audio acquisition devices, respectively disposed in a monitoring region and at least two of which have effective pickup ranges that at least partially overlaps for acquiring an environmental audio signal; a main processor, in signal communication with the audio acquisition devices to receive the environmental audio signal output by the audio acquisition devices, identify whether the environmental audio signal contains an abnormal event audio and generate abnormal location information based on at least two environmental audio signals that simultaneously contain the abnormal event audio; and at least one camera device, in signal communication with the main processor to adjust a shooting view and focus based on the abnormal location information for shooting an abnormal event and generating an abnormal event image.

The audio acquisition devices are respectively connected to a slave processor, and the slave processor is configured to compare whether the environmental audio signal contains an abnormal sound; wherein the environmental audio signal is transmitted to the main processor when the environmental audio signal contains the abnormal sound, and the environmental audio signal is not transmitted to the main processor when the environmental audio signal does not contain the abnormal sound.

The abnormal event identification method further includes steps of: enabling, by the main processor, at least one of the audio acquisition devices adjacent to the audio acquisition device that provides the environmental audio signal and/or a warning signal, based on an identification device distribution map, to receive the environmental audio signals with the effective pickup ranges at least partially overlapping. Similarly, the main processor of the abnormal event identification system may further achieve the purpose of receiving the environmental audio signals whose effective pickup range at least partially overlaps through the identification device distribution map.

The method further includes, before the transmitting the abnormal location information to at least one camera device, steps of: setting a saving cycle parameter to change an operating state of at least one of the audio acquisition devices that is adjacent to the abnormal location information and is not enabled, wherein the saving cycle parameter is: RT=t₀−ΣΔtₙ; RT is a continuously decreasing variable, representing a remaining operating time of nearby one of the audio acquisition devices; t₀ is an initial monitoring period; Δtₙ is a decreasing unit time for each identification cycle. Similarly, in the abnormal event identification system, the saving cycle parameter may be set by the main processor.

When the RT decreases to zero and no abnormal event audio is identified during the cycle, a step is further included: the operating state of at least one of the audio acquisition devices that is activated by the saving cycle parameter is changed to an off state.

When the RT decreases to zero and the abnormal event audio is identified during the cycle, a step is further included: the RT is reset to the t₀ so that at least one of the audio acquisition devices adjacent to the abnormal location information continuously receives the environmental audio signal.

The generating the abnormal location information further includes steps of: calculating an orientation and a distance of a location where the abnormal event occurs in combination with a geometric orientation parameter corresponding to each of the audio acquisition devices based on an identification probability (P₁, P₂, . . . , Pₘ) and an audio intensity (L₁, L₂, . . . , Lₘ) of each of the audio acquisition devices obtained in an identification step, wherein m is a number of the audio acquisition devices and i=1 . . . m; wherein a calculation of the orientation is performed by weighting the identification probability and the audio intensity of each of the audio acquisition devices to estimate a direction of a sound source, and comprises any of the following formulas for performing the calculation of the orientation: a vector formula of U=Σ(Pᵢ×Lᵢ×uᵢ)/Σ(Pᵢ×Lᵢ) and an azimuth formula: θ=Σ(Pᵢ×Lᵢ×θᵢ)/Σ(Pᵢ×Lᵢ), wherein U is a unit vector representing an orientation of the abnormal event audio, θ is an azimuth parameter of the abnormal event audio, uᵢ is a known geometrical orientation unit vector of an i-th audio acquisition device, θᵢ is a known azimuth of the i-th audio acquisition device, Pᵢ is an identification probability generated by the i-th audio acquisition device after the identification step, Lᵢ is an audio intensity received by the i-th audio acquisition device; a formula for calculating the distance is: R=k×Lₘₐₓ\hat{ }(−½), wherein R is a parameter of the distance of an abnormal event audio signal, representing a relative distance between the sound source and an audio acquisition device with a highest identification probability, Lₘₐₓ is the audio intensity obtained by measuring the audio acquisition device with a highest identification probability (Pₘₐₓ), k is a proportionality constant, representing a sound attenuation coefficient in an environment, and Lₘₐₓ\hat{ }(−½) represents that the distance is inversely proportional to a square root of the audio intensity. Similarly, in the abnormal event identification system, the above calculation process may be executed by the main processor.

The adjusting a shooting view and focusing, by at least one of the camera devices, based on the abnormal location information further includes steps of: calculating an abnormal event coordinate corresponding to the abnormal location information in a region coordinate map based on the region coordinate map corresponding to locations configured for each of the audio acquisition devices and the camera device; generating a camera adjustment command based on the abnormal event coordinate and a relative position of the camera device in the region coordinate map, and transmitting the camera adjustment command to the camera device; and adjusting, by the camera device, the shooting view, and focusing based on the camera adjustment command. Similarly, in the abnormal event identification system, the region coordinate map may be pre-stored in the main processor to execute the above process.

The invention further provides an abnormal event warning method, which includes: executing the abnormal event identification method as mentioned above to generate the abnormal location information; enabling at least one warning device adjacent to the abnormal location information through a main processor based on a warning device distribution map.

The invention further provides an abnormal event warning system, which includes: a main processor, configured to execute the abnormal event identification method as mentioned above to generate the abnormal location information; at least one warning device, configured in a monitoring region to alert the presence of humans or animals active in the abnormal location information; wherein the main processor serves as the basis for enabling the at least one warning device located adjacent to the abnormal location information based on a warning device distribution map.

In summary, the invention may claim the following effects: (1) Through a distributed configuration of the plurality of audio acquisition devices and partially-overlapping effective pickup ranges thereof, multi-point identification and cross-comparison of sound events may be performed, and by enabling the slave processor on each device to perform audio identification in real time at edge ends, the amount of raw audio data that needs to be transmitted to the main processor is greatly reduced, thereby reducing network load and energy consumption. (2) The main processor may perform weighted calculations based on the identification probability and the audio intensity of each audio acquisition device to estimate the orientation and the distance of the abnormal event audio, thereby generating the abnormal location information with spatial positioning capabilities and overcoming the problem that traditional single-point sensing systems cannot determine the direction of the sound source. (3) By designing the cycle parameter (RT=t₀−ΣΔtₙ), the system may automatically achieve a balance between monitoring density and energy consumption. When no abnormal events are identified in the monitoring region for an extended period of time, the system may gradually shut down nearby nodes based on the RT value and enter a low-power mode; if an abnormal sound source (such as a chainsaw or a cracking sound) reappears, the RT value is reset in real time and monitoring is restarted, making the overall architecture combine real-time performance with energy efficiency, and particularly suitable for outdoor environments where power or communication conditions are limited. (4) In the invention, in combination of the camera device and the warning device, the main processor may further automatically drive the camera device to adjust the view and focus based on the abnormal location information, so as to realize sound-source-guided image locking and real-time evidence collection, and at the same time enable the nearby warning devices to provide sound and light alarms to achieve a rapid warning or deterrent effect. (5) The overall architecture may operate on a low-power microcontroller platform or wireless sensing node, and is suitable for a variety of applications such as forest anti-theft, nighttime security monitoring on construction sites, border patrol and wildlife observation; the architecture combines the accuracy, real-time performance and energy efficiency of sound and image identification, and has high scalability and self-management capabilities.

### BRIEF DESCRIPTION OF THE DRAWINGS

FIG. 1 is a first flowchart of an abnormal event identification method according to an embodiment of the invention;

FIG. 2 is a second flowchart of the abnormal event identification method according to an embodiment of the invention;

FIG. 3 is a diagram of modules of an abnormal event identification system according to an embodiment of the invention;

FIG. 4 is a diagram of modules of an abnormal event warning system according to an embodiment of the invention.

### DETAILED DESCRIPTION OF THE INVENTION

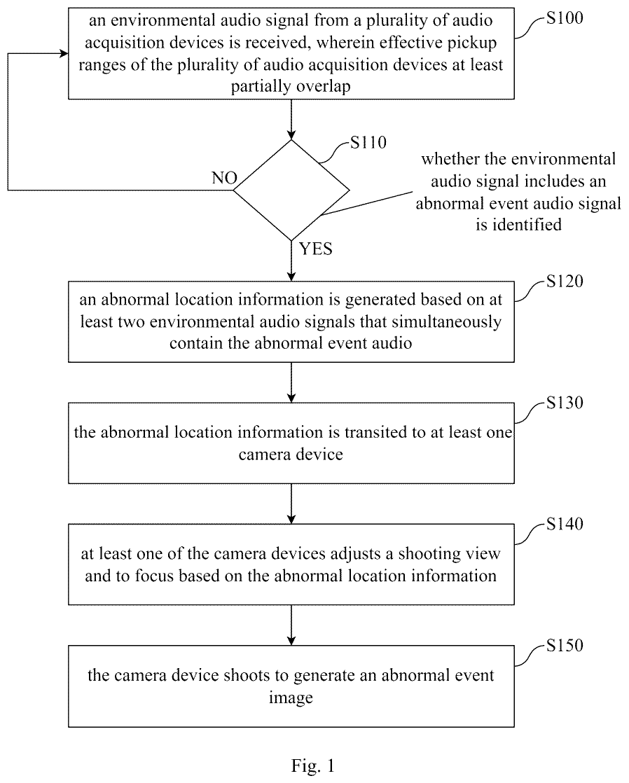

As shown in FIG. 1, the invention provides an abnormal event identification method, the process of which includes steps S100 to S150, to illustrate how the invention performs sound source acquisition, positioning and video recording through a plurality of audio acquisition devices.

As shown in the step S100, an environmental audio signal from a plurality of audio acquisition devices is received, wherein effective pickup ranges of the plurality of audio acquisition devices at least partially overlap. Specifically, the audio acquisition device may be microphone modules distributed throughout a monitoring region, with some overlap in the pickup range between the modules, so that two or more audio acquisition devices simultaneously receive an audio signal of a sound source when the sound source appears in the environment for facilitating subsequent determination of the direction and location of the sound source. In practical applications, 4 to 8 audio acquisition devices (e.g., microphone modules) may be deployed in the monitoring region, with a spacing of 0.5 to 15 meters between them; the effective pickup range of adjacent modules should at least partially overlap (e.g., an overlapping angle of 20° to 60°, or an overlapping area of ≥20%) to ensure that when a single sound source appears in the environment, at least two audio acquisition devices may receive the corresponding audio at the same time. The audio acquisition devices may be arranged in linear, triangular, or circular patterns. In mountainous roadside scenarios, a hybrid layout of “triangle+linear extension” may be preferred to balance positioning stability and installation cost.

As shown in the step S110, whether the environmental audio signal includes an abnormal event audio signal is identified. If the environmental audio signal includes the abnormal event audio, the process proceeds to step S120; otherwise, the process returns to the step S100 to continue receiving the environmental audio signal. The step may be performed by using a main processor or an edge computing module to perform sound feature comparison and spectrum analysis to determine whether the received audio signal meets preset abnormal event conditions, such as chainsaw sound, cracking sound or other abnormal sound in specific frequency bands. In practical applications, each of the audio acquisition devices acquires the audio at a sampling rate of 16 kHz to 48 kHz, performs DC removal, pre-emphasis, framing (25 ms window, 10 ms overlap) and normalization, and then extracts features that are beneficial to event identification (e.g., Mel cepstrum, bandpass power ratio, harmonic energy index, etc.). The features may be input into edge computing models (such as lightweight CNN/CRNN) to generate an identification probability of the abnormal event audio (such as chainsaw sounds) belonging to the target Pᵢ∈[0,1]. The term “window” refers to a short segment of audio information within a given time frame.

As shown in the step S120, an abnormal location information is generated based on at least two environmental audio signals that simultaneously contain the abnormal event audio. The abnormal location information may be calculated by a time difference, a sound intensity difference or a phase difference between multiple sound sources to estimate a location and a distance of the sound source of the abnormal event.

As shown in the step S130, the abnormal location information is transited to at least one camera device. The abnormal location information may include data parameters representing the direction and the distance of the sound source, which may be used by the camera device to adjust a shooting view.

As shown in the step S140, at least one of the camera devices adjusts a shooting view and to focus based on the abnormal location information. Specifically, the camera device may automatically rotate a lens angle and adjust a focal length based on the direction and the distance indicated by the abnormal location information, so that the captured image may cover a region where the abnormal event occurs. In a specific embodiment, the main processor has a built-in region coordinate map that records a location information (including coordinates and orientation) of each audio acquisition device and the camera device. Once (U,R) and (x, y, z) are obtained, the main processor calculates a horizontal rotation angle (pan), a vertical elevation angle (tilt), and a focal length/focus parameters (zoom/focus) of a target point relative to a selected camera device, and generates a camera adjustment command (PTZ/F).

As shown in the step S150, the camera device shoots to generate an abnormal event image. In a specific embodiment, the abnormal event image may be uploaded to a remote server, a monitoring platform, or an warning system for further analysis or to preserve evidence, so as to achieve the purpose of real-time monitoring and event reporting. After the camera device completes the adjustment of the view, the camera device triggers recording and image capture in the same event window (e.g., 5~10 fps forensic snapshot+30 s buffer recording). The image may contain event timestamps and coordinate watermarks. The data is uploaded to a management platform via 4G/5G or LoRaWAN/Ethernet for backend auditing or real-time dispatch.

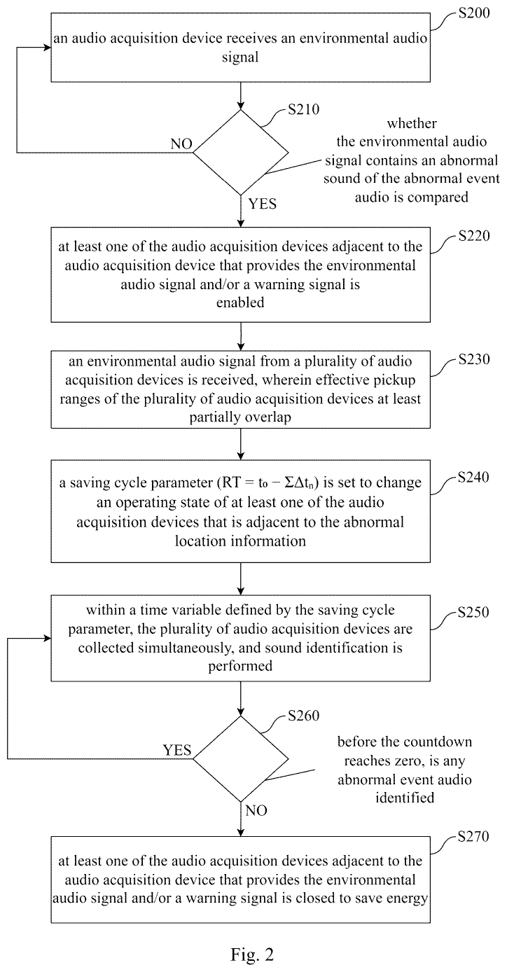

As shown in FIG. 2, the embodiment illustrates a main-slave abnormal event identification process. The overall process includes steps S200 to S270, in which edge identification is performed by a slave processor of each audio acquisition device, and the main processor dynamically enables nearby devices and performs energy-saving control and positioning calculations based on an identification device distribution map.

As shown in the step S200, an audio acquisition device receives an environmental audio signal.

As shown in the step S210, whether the environmental audio signal contains an abnormal sound of the abnormal event audio is compared. If the environmental audio signal contains the abnormal event audio, the process proceeds to step S220; otherwise, the process returns to the step S200 to continue receiving the environmental audio signal.

The slave process of each audio acquisition device compares in real time whether the environmental audio signal received therefrom contains an abnormal sound of the abnormal event audio. In a specific embodiment, the slave processor may preprocess the input audio (DC removal, pre-emphasis, framing, and energy normalization) and then use a lightweight model (such as CNN or CRNN) to calculate the probability value of the audio belonging to the target event. The abnormal sound could be, for example, sampled at 16 kHz, with a 25 ms window and a 10 ms hop; if p≥0.6 lasts for 200 ms, it indicates that the environmental audio signal contains the abnormal sound. When the abnormal sound is determined to be contained, the slave processor transmits the environmental audio signal or a warning flag to the main processor; if no abnormal sound is determined to be contained, no transmission is made to reduce communication load.

As shown in the step S220, at least one of the audio acquisition devices adjacent to the audio acquisition device that provides the environmental audio signal and/or a warning signal is enabled. In a specific embodiment, after receiving the report, the main processor selects at least one of the audio acquisition devices that is spatially adjacent to a trigger node and enables based on the identification device distribution map (which stores the coordinates and the orientation of each audio acquisition device, for example, the identification device distribution map data includes the coordinates (xᵢ, yᵢ, zᵢ) or the azimuth θᵢ of each audio acquisition device), which allows the device to enter a normal monitoring mode to receive the environmental audio signal within the overlapping range. For example, an audio acquisition device with a radius of rₙ=25 m or the three nearest nodes may be considered as a neighbor.

As shown in the step S230, an environmental audio signal from a plurality of audio acquisition devices is received, wherein effective pickup ranges of the plurality of audio acquisition devices at least partially overlap.

As shown in the step S240, a saving cycle parameter (RT=t₀−ΣΔtₙ) is set to change an operating state of at least one of the audio acquisition devices that is adjacent to the abnormal location information. RT is the continuously decreasing variable, representing a remaining operating time of the nearby audio acquisition devices, t₀ is the initial monitoring period, and Δtₙ is the decreasing unit time for each identification cycle. In a specific embodiment, to avoid long-time full network wake-up, the main processor sets the saving cycle parameter for the already-enabled nearby nodes to control the operating time. The nodes are enabled, starting with RT=t₀ and decreasing as RT in subsequent identification loops. If RT=0 and no further abnormal event audio is identified during the period, then the nearby node is shut down; if abnormal event audio is identified again during the period, then the RT=t₀ is reset to extend the monitoring time. For example: t₀=10 s, Δtₙ=1 s; If the event is detected again after 6 seconds, RT is immediately recovered to 10 s.

In one implementation, the main processor may control an enabling time and a recording length of the audio acquisition device through the saving cycle parameter (RT=t₀−ΣΔtₙ) to dynamically adjust the acquisition method of the environmental audio signal. Unlike traditional methods of recording with a fixed length or long continuous recording, the embodiment may perform identification by recording short audio segments (e.g., 1 to 3 seconds each). When the identification result shows no abnormal event audio, the next short segment recording may be started immediately. Given the potential differences in processing speed and data transmission latency for the processor, the next audio acquisition may be initiated while the previous environmental audio signal is still being processed, thus creating a parallel recording and identification process. This allows for continuous monitoring through multiple short recordings during the countdown period of the time-saving cycle (RT), rather than a single long recording, thereby improving the real-time performance of identification and the efficiency of continuous monitoring. Therefore, setting the saving cycle parameter may not only significantly reduce memory usage and computational latency, but also reset the RT in real time when the abnormal event audio occurs, maintaining high monitoring frequency and low power consumption operation.

As shown in the step S250, within a time variable defined by the saving cycle parameter, the plurality of audio acquisition devices are collected simultaneously, and sound identification is performed.

In a specific embodiment, within the saving cycle parameter, the main processor collects data from at least two nodes that simultaneously possess the abnormal event audio (audio intensity Lᵢ, identification probability Pᵢ, node orientation parameters uᵢ or θᵢ), and aligns using simple timestamps or sample-level sliding windows to ensure that the same event segment is processed consistently. For example, a time alignment error in +50 ms is allowed; the data is aggregated in 200 ms windows with 50% overlap.

Further, the main processor may calculate an orientation and a distance of a location where the abnormal event occurs in combination with a geometric orientation parameter corresponding to each of the audio acquisition devices based on an identification probability (P₁, P₂, . . . , Pₘ) and an audio intensity (L₁, L₂, . . . , Lₘ) of each of the audio acquisition devices obtained in an identification step, wherein m is a number of the audio acquisition devices and i=1 . . . m. Wherein a calculation of the orientation is performed by weighting the identification probability and the audio intensity of each of the audio acquisition devices to estimate a direction of a sound source, and comprises any of the following formulas for performing the calculation of the orientation:

a vector formula: U=Σ(Pᵢ×Lᵢ×uᵢ)/Σ(Pᵢ×Lᵢ); an azimuth formula: θ=Σ(Pᵢ×Lᵢ×θᵢ)/Σ(Pᵢ×Lᵢ).

U is a unit vector representing an orientation of the abnormal event audio; θ is an azimuth parameter of the abnormal event audio; uᵢ is a known geometrical orientation unit vector of an i-th audio acquisition device; θᵢ is a known azimuth of the i-th audio acquisition device; Pᵢ is an identification probability generated by the i-th audio acquisition device after the identification step; Lᵢ is an audio intensity received by the i-th audio acquisition device.

A formula for calculating the distance is: R=k×Lₘₐₓ\hat{ }(−½), wherein Lₘₐₓ is taken from the node with the highest identification probability of Pₘₐₓ.

R is a parameter of the distance of an abnormal event audio signal, representing a relative distance between the sound source and an audio acquisition device with a highest identification probability; Lₘₐₓ is the audio intensity obtained by measuring the audio acquisition device with a highest identification probability (Pₘₐₓ); k is the proportionality constant, representing a sound attenuation coefficient in an environment; Lₘₐₓ\hat{ }(−½) represents that the distance is inversely proportional to a square root of the audio intensity.

For example, assuming four audio acquisition devices (i.e., four nodes) are configured in the monitoring region, the identification probability and the audio intensity thereof are respectively: (Pᵢ, Lᵢ)=(0.82, 0.9), (0.77, 0.7), (0.18, 0.2), (0.12, 0.1); if the first node (u₁) points northeast and the second node (u₂) points due east, then the weighted calculated azimuth U falls in the east-northeast direction. Further, let k=12, Lₘₐₓ=0.9 (node 1), then R≈12/\sqrt{0.9}≈12.65 (relative distance). Therefore, the abnormal location information may be estimated to be located in the east-northeast direction of the audio acquisition device with the highest identification probability, and the relative distance is approximately 12.65. In other words, the location of the sound source of the abnormal event is east-northeast relative to the location of the audio acquisition device with the highest probability of identification, and the distance is a relative value of approximately 12.65.

Therefore, the main processor converts (U,R) to the abnormal event coordinate (x, y, z) on the region coordinate map and calculates the zoom parameters relative to the selected camera device, such as pan, tilt, and zoom, to form the camera adjustment command. For example, if the camera device is at coordinate (0, 0, 6 m) and faces due east, and the event coordinate is estimated as (18, 4, 0), then pan≈12.5°, tilt≈−17.9°, and Zoom≈19.2 m.

As shown in the step S260, before the countdown reaches zero, is any abnormal event audio identified. If the abnormal event audio is identified, the process returns to the step S250 to continue with voice recognition; otherwise, the process continues to the step S270.

In a specific embodiment, to reduce accidental touches and extend system battery life, one or more of the following rules may be adopted: (1) Double Threshold and Continuous Condition: When the identification probability p of M consecutive analysis windows (e.g., M=2, each window 200 ms, 50% overlap) is greater than a trigger threshold τₒₙ (e.g., 0.6), it is determined that “identified”; when N consecutive analysis windows p<τ_{off} (e.g., 0.4), it is determined that “not identified”. (2) RT Reset Rule: If “identified” is detected during the RT countdown, RT=t₀ is reset to extend the observation period; if only a short-term trigger occurs in a single window (e.g., p is between τ_{off} and τₒₙ), no reset is performed, and only the temporary direction is updated.

In a specific embodiment, for example, when the event is triggered, t₀=10 seconds are set, so RT=10 s. When two consecutive windows have a p≥0.6 during the period t=0~3 s, it is considered a valid identification, and RT is restored from 7 s to 10 s; when the p is between 0.45 and 0.55 due to wind noise during the period t=5~7 s, and τₒₙ is not reached, RT is not reset; when two consecutive windows with p≥0.6 are identified again at t=8.2 s, RT is restored to 10 s again. In this way, important nodes may be automatically kept on during long-term monitoring, automatically enter low-power mode when there are no abnormalities, and immediately resume monitoring when the abnormal event occurs again, thus balancing energy efficiency and identification continuity.

As shown in the step S270, at least one of the audio acquisition devices adjacent to the audio acquisition device that provides the environmental audio signal and/or a warning signal is closed to save energy.

In a specific embodiment, the nearby audio acquisition devices that are awakened by the event are switched to off or low-cycle monitoring (e.g., wake up 100 ms every 2 seconds). Alternatively, the original trigger node or central node may be retained to maintain single-point monitoring, so that the next event may quickly wake up the nearby devices.

According still another embodiment, the embodiment illustrates an abnormal event warning method. The method combines the above abnormal event identification process (as shown in FIGS. 1 and 2). After the main processor generates the abnormal location information, the warning devices adjacent to the abnormal event location may be automatically enabled based on a warning device distribution map, thereby providing real-time warnings to humans or animals. The main processor receives the abnormal location information generated by the abnormal event identification method. The abnormal location information includes the orientation, distance, or coordinates of the region where the event occurs, for example, represented in the vector formula (U, R) or three-dimensional coordinates (x, y, z) In a specific embodiment, the main processor may include the event type (such as “chainsaw sound”, “glass breakage”, “shouting sound”, “vehicle collision” etc.) in the identification results as the basis for determining the warning mode.

Therefore, the main processor determines at least one warning device that is adjacent to the abnormal location information based on the warning device distribution map. The distribution map may include location coordinates, types, and communication addresses of a plurality of warning devices (such as alarm lights, buzzers, speakers, or ground vibration warning modules). For example, the warning device distribution map records the three-dimensional coordinates (xⱼ, yⱼ, zⱼ), the coverage radius, the warning type (sound/light/vibration) and the connection ID of each device. The main processor may determine whether the region belongs to the vicinity of the abnormal event coordinates based on the distance condition.

In a specific embodiment, if the abnormal event occurs in a certain region of the monitoring region (e.g., with coordinates (12, 8, 0)), and the warning device distribution map shows that three devices are configured in that region:
A1 (Buzzer Alarm, Location of (10, 7, 0), Radius of 5 m);
A2 (Flashing Warning Light, Location of (15, 9, 0), Radius of 6 m);
A3 (Broadcast Speaker, Location of (20, 8, 0), Radius of 8 m).

The main processor determines that the event coordinates are simultaneously within the effective radius of A1 and A2, and triggers both to start.

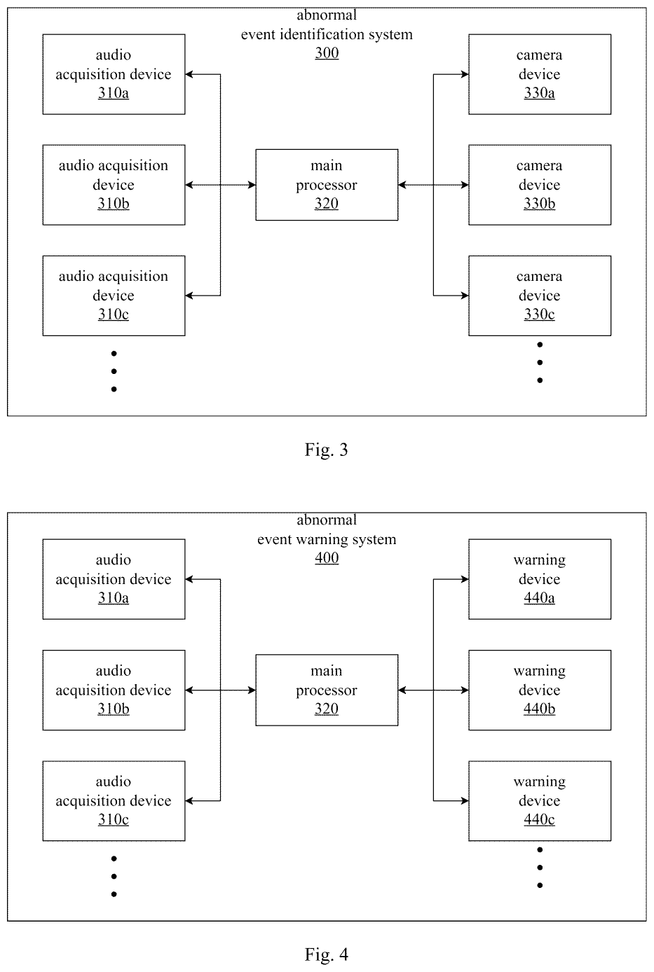

With reference to FIG. 3, the embodiment discloses an abnormal event identification system 300, which includes a plurality of audio acquisition devices 310a to 310c, a main processor 320 and at least one camera device 330a to 330c. The abnormal event identification system 300 may be applied to monitoring environments such as mountainous areas, forest roads, or industrial parks to identify abnormal event audio signals, generate abnormal location information, and control the camera devices 330a to 330c to adjust the view and focus in order to obtain the abnormal event images.

The audio acquisition devices 310a to 310c are respectively mounted at different locations in the monitoring region, such as along mountain paths or roads, and the effective pickup range of adjacent audio acquisition devices at least partially overlaps to form a continuous acoustic monitoring network. Each of the audio acquisition devices 310a to 310c may include a microphone module, a front-end filtering circuit, and a built-in slave processor. Specifically, each of the audio acquisition devices 310a to 310c is respectively configured in the monitoring region and captures the environmental audio signals through the microphone module thereof. The built-in slave processor of each of the audio acquisition devices 310a to 310c may perform edge identification calculations to preliminarily determine whether the acquired environmental audio contains the abnormal event audio.

In a specific embodiment, the slave processors of the audio acquisition devices 310a to 310c may process the acquired environmental audio signals in real time, perform preliminary spectrum analysis and feature comparison, and determine whether the audio signal contains the abnormal event audio. For example, if a sound wave with a frequency spectrum energy concentrated between 250 Hz and 1.2 kHz and exhibiting periodic sawing characteristics is detected in the monitored forest region, it can be preliminarily identified as the sound of a chainsaw; the audio data is then marked as a suspected abnormal event signal and transmitted to the main processor 320.

The main processor 320 is in signal communication with the audio acquisition devices 310a to 310c to receive the environmental audio signals and identify whether the signals include the abnormal event audio. When at least two audio acquisition devices (e.g., 310a and 310b) identify the sound of a chainsaw within the same time window, the main processor 320 calculates the direction and distance of the sound source based on the volume intensity and time difference of the two audio signals to generate the abnormal location information.

The main processor 320 may use the vector formula: U=Σ(Pᵢ×Lᵢ×uᵢ)/Σ(Pᵢ×Lᵢ) and the azimuth formula: θ=Σ(Pᵢ×Lᵢ×Θᵢ)/Σ(Pᵢ×Lᵢ) mentioned above to perform azimuth calculation. Then, the formula R=k×Lₘₐₓ\hat{ }(−½) mentioned above is used to perform distance calculation.

The camera devices 330a to 330c is in signal communication with the main processor 320. Once the main processor 320 generates the abnormal location information, the main processor may control the camera devices (such as 330a and 330b) adjacent to the location to adjust the shooting view and to focus.

In still another specific embodiment, the camera devices 330a to 330c may be camera modules with pan-tilt control. The main processor 320 converts the abnormal location information into coordinate angles (such as azimuth angle θ and elevation angle φ), and transmits control commands to drive the camera device to adjust a lens direction, lock possible event regions and start recording or transmitting real-time video stream.

In a specific example, in forest monitoring applications, when the audio acquisition devices 310a and 310b simultaneously identify sawing sounds, the devices transmit the corresponding environmental audio signals to the main processor 320. After processing, the main processor 320 determines that the sound source is located at (240, 450, 21). The main processor 320 immediately transmits a control signal to the camera device 330a, instructing the device to turn the shooting view to the direction of the coordinate and to start autofocus.

The camera device 330a then captures an image of a suspicious person using a chainsaw. The main processor 320 simultaneously records the abnormal event image and timestamp, and may further transmit the same to a backend monitoring center for alerts or archiving.

In another specific embodiment, the slave processor may perform spectrum preprocessing and feature comparison, such as identifying periodic sound waves in a frequency range of 250 Hz to 1.2 kHz; if the feature value matches the chainsaw sound sample, the corresponding environmental sound signal (which may further include a sound identification flag) is transmitted to the main processor 320.

The main processor 320 is in signal communication with each of the audio acquisition devices 310a to 310c to receive audio data or identification flags from a plurality of nodes. When at least two audio acquisition devices (e.g., 310a and 310b) identify the sound of a chainsaw within the same time period, the main processor 320 may calculate the location and the distance of the sound source based on the audio intensity and the identification probability of each node, and generates the abnormal location information.

With reference to FIG. 4, the embodiment further discloses an abnormal event warning system 400, which may be applied to forests, industrial parks or large outdoor regions to identify the abnormal event audio in real time, generate the abnormal location information, and control the warning devices 440a to 440c in the nearby region to provide real-time warnings. When the main processor 320 determines that the abnormal event audio is an illegal activity (such as illegal logging), the warning devices 440a to 440c in the nearby region may be enabled to issue an optical or acoustic alarm on the spot, and at the same time notify the patrol personnel to go to the scene.

Specifically, the abnormal event warning and identification system 400 mainly includes a plurality of audio acquisition devices 310a to 310c with respective built-in slave processors, a main processor 320, and a plurality of warning devices 440a to 440c.

Based on the abnormal location information, the main processor 320 may further query the warning device distribution map in the system database to determine which warning devices (such as at least one of 440a to 440c) are located in the vicinity of the abnormal location. If the distance meets the condition (e.g., the distance is less than 50 meters), the main processor 320 will send the control command to the corresponding warning device (at least one of 440a to 440c) to enable the audible and visual warning.

In a specific example, assuming the abnormal event identification system 300 is mounted in the forestry monitoring region, when the audio acquisition devices 310a and 310b simultaneously identify the sound of chainsaws suspected of illegally logging forests, the main processor 320 estimates the location of the sound source to be approximately coordinates (240, 450, 21) after calculation.

After the distribution map of the warning devices is queried, the main processor 320 determines that the warning devices 440a and 440b are located within a 30-meter radius of the location; then the control commands are sent to make the warning device 440a flash a bright red light (with a frequency of 2 Hz), and the warning device 440b emit a 90 dB buzzer alarm for 15 seconds. Meanwhile, the main processor 320 uploads the abnormal location information and event time to a remote monitoring center.

In an optional embodiment, the warning devices 440a to 440c may take many forms, including buzzers, flashlights, voice broadcasting devices or wireless relay modules. The main processor 320 may automatically select the appropriate warning mode according to the event type. For example, if the sound of a chainsaw is detected (which is an illegal logging event), a sound and light synchronous output mode is adopted; if the sound of explosion or collision is detected, the surrounding people are reminded to evacuate by broadcasting; if the sound of people calling for help is detected, a parallel mode in the form of voice broadcast and remote notification is used.

In another embodiment, the main processor 320 may automatically adjust a warning duration based on the event duration or identification results. For example, a duration parameter T_{w}=30 s is set; if the event continues within this duration, the warning output is extended; if the event disappears, the warning intensity is gradually reduced and the warning device is turned off to save energy and avoid false alarms.

The abnormal event identification system 300 may also perform closed-loop feedback. When the alarm devices 440a to 440c are enabled, the built-in microphones thereof may transmit sound wave features, which is marked by the main processor 320 as “system-generated audio” to avoid misjudging the warning sound as a new abnormal event and to ensure accurate identification.

In summary, the abnormal event warning system 400 in the embodiment integrates multi-point audio acquisition, sound source localization and warning control functions, and may identify the abnormal event audio in real time and trigger nearby warning devices 440a to 440c for local warning; the system is particularly suitable for applications such as forest protection against illegal mining, nighttime construction site security monitoring and boundary intrusion identification, and may provide accurate and real-time warning responses under an operating condition of low power consumption.

What is claimed is:

1. An abnormal event identification method, comprising:
receiving an environmental audio signal from a plurality of audio acquisition devices, wherein effective pickup ranges of the audio acquisition devices at least partially overlap;
identifying whether the environmental audio signal comprises an abnormal event audio signal;
generating an abnormal location information based on at least two environmental audio signals that simultaneously contain the abnormal event audio;
transmitting the abnormal location information to at least one camera device;
controlling at least one of the camera devices to adjust a shooting view and to focus based on the abnormal location information; and
controlling at least one of the camera devices to shoot an image of an abnormal event and generating an abnormal event image.

2. The abnormal event identification method according to claim 1, further comprising, before a main processor receives the environmental audio signals, steps of:
comparing in real time whether the environmental audio signal contains an abnormal sound of the abnormal event audio through a slave processor configured for each of the audio acquisition devices;
transmitting, by the slave processor, the environmental audio signal to the main processor when the environmental audio signal contains the abnormal sound; and
not transmitting, by the slave processor, the environmental audio signal to the main processor when the environmental audio signal does not contain the abnormal sound.

3. The abnormal event identification method according to claim 2, further comprising steps of:
enabling, by the main processor, at least one of the audio acquisition devices adjacent to the audio acquisition device that provides the environmental audio signal and/or a warning signal, based on an identification device distribution map, to receive the environmental audio signals with the effective pickup ranges at least partially overlapping.

4. The abnormal event identification method according to claim 3, further comprising, before transmitting the abnormal location information to at least one camera device, steps of:
setting a saving cycle parameter to change an operating state of at least one of the audio acquisition devices that is adjacent to the abnormal location information and is not enabled;
wherein the saving cycle parameter is: RT=t₀−ΣΔtₙ;
RT is a continuously decreasing variable, representing a remaining operating time of nearby one of the audio acquisition devices,
t₀ is an initial monitoring period, and
Δtₙ is a decreasing unit time for each identification cycle.

5. The abnormal event identification method according to claim 4, further comprising, when the RT decreases to zero and no abnormal event audio is identified during the cycle, steps of:
changing the operating state of at least one of the audio acquisition devices that is activated by the saving cycle parameter to an off state.

6. The abnormal event identification method according to claim 4, further comprising, when the RT decreases to zero and the abnormal event audio is identified during the cycle, steps of:
resetting the RT to the to so that at least one of the audio acquisition devices adjacent to the abnormal location information continuously receives the environmental audio signal.

7. The abnormal event identification method according to claim 1, wherein the generating the abnormal location information further comprises steps of:
calculating an orientation and a distance of a location where the abnormal event occurs in combination with a geometric orientation parameter corresponding to each of the audio acquisition devices based on an identification probability (P₁, P₂, . . . , Pₘ) and an audio intensity (L₁, L₂, . . . , Lₘ) of each of the audio acquisition devices obtained in an identification step, wherein m is a number of the audio acquisition devices and i=1 . . . m;
wherein a calculation of the orientation is performed by weighting the identification probability and the audio intensity of each of the audio acquisition devices to estimate a direction of a sound source, and comprises any of the following formulas for performing the calculation of the orientation:
$$\begin{matrix}a vector formula : U = \sum ( {P}_{i} \times {L}_{i} \times {u}_{i} ) / \sum ( {P}_{i} \times {L}_{i} ) , and \\ a azimuth formula : θ = \sum ( {P}_{i} \times {L}_{i} \times {θ}_{i} ) / \sum ( {P}_{i} \times {L}_{i} ) ,\end{matrix}$$
U is a unit vector representing an orientation of the abnormal event audio,
θ is an azimuth parameter of the abnormal event audio,
uᵢ is a known geometrical orientation unit vector of an i-th audio acquisition devices,
θᵢ is a known azimuth of the i-th audio acquisition device,
Pᵢ is an identification probability generated by the i-th audio acquisition device after the identification step, and
Lᵢ is an audio intensity received by the i-th audio acquisition device;
wherein a formula for calculating the distance is: R=k×Lₘₐₓ\hat{ }(−½),
R is a parameter of the distance of an abnormal event audio signal, representing a relative distance between the sound source and an audio acquisition device with a highest identification probability,
Lₘₐₓ is the audio intensity obtained by measuring the audio acquisition device with a highest identification probability (Pₘₐₓ),
k is a proportionality constant, representing a sound attenuation coefficient in an environment, and
Lₘₐₓ\hat{ }(−½) represents that the distance is inversely proportional to a square root of the audio intensity.

8. The abnormal event identification method according to claim 1, wherein adjusting a shooting view and focusing, by at least one of the camera devices, based on the abnormal location information further comprises steps of:
calculating an abnormal event coordinate corresponding to the abnormal location information in a region coordinate map based on the region coordinate map corresponding to locations configured for each of the audio acquisition devices and the camera device;
generating a camera adjustment command based on the abnormal event coordinate and a relative position of the camera device in the region coordinate map, and transmitting the camera adjustment command to the camera device; and
adjusting, by the camera device, the shooting view, and focusing based on the camera adjustment command.

9. The abnormal event identification method according to claim 1, further comprising steps of:
enabling at least one warning device adjacent to the abnormal location information through a main processor based on a warning device distribution map.

10. An abnormal event identification system, comprising:
a plurality of audio acquisition devices, respectively disposed in a monitoring region and at least two of which have effective pickup ranges that at least partially overlap, for acquiring an environmental audio signal;
a main processor, in signal communication with the audio acquisition devices to receive the environmental audio signal output by the audio acquisition devices, identify whether the environmental audio signal contains an abnormal event audio and generate abnormal location information based on at least two environmental audio signals that simultaneously contain the abnormal event audio; and
at least one camera device, in signal communication with the main processor to adjust a shooting view and focus based on the abnormal location information for shooting an abnormal event and generating an abnormal event image.

11. The abnormal event identification system according to claim 10, wherein the audio acquisition devices are respectively connected to a slave processor, and the slave processor is configured to compare whether the environmental audio signal contains an abnormal sound; wherein the environmental audio signal is transmitted to the main processor when the environmental audio signal contains the abnormal sound, and the environmental audio signal is not transmitted to the main processor when the environmental audio signal does not contain the abnormal sound.

12. The abnormal event identification system according to claim 10, wherein the main processor further enables at least one of the audio acquisition devices adjacent to the audio acquisition device that provides the environmental audio signal and/or a warning signal, based on an identification device distribution map, to receive the environmental audio signals with the effective pickup ranges at least partially overlapping.

13. The abnormal event identification system according to claim 10, wherein the main processor further changes an operating state of at least one of the audio acquisition devices that is adjacent to the abnormal location information and is not enabled based on a saving cycle parameter;
wherein the saving cycle parameter is: RT=t₀−ΣΔtₙ;
RT is a continuously decreasing variable, representing a remaining operating time of the nearby ones of the audio acquisition devices,
t₀ is an initial monitoring period, and
Δtₙ is a decreasing unit time for each identification cycle.

14. The abnormal event identification system according to claim 13, wherein when the RT decreases to zero and no abnormal event audio is identified during the cycle, the operating state of at least one of the audio acquisition devices that is activated by the saving cycle parameter is changed to an off state.

15. The abnormal event identification system according to claim 13, wherein when the RT decreases to zero and the abnormal event audio is identified during the cycle, the RT is reset to the to so that at least one of the audio acquisition devices adjacent to the abnormal location information continuously receives the environmental audio signal.

16. The abnormal event identification system according to claim 10, wherein the main processor generates the abnormal location information is performed by calculating an orientation and a distance of a location where the abnormal event occurs in combination of a geometric orientation parameter corresponding to each with the audio acquisition devices based on an identification probability (P₁, P₂, . . . , Pₘ) and an audio intensity (L₁, L₂, . . . , Lₘ) of each of the audio acquisition devices obtained in an identification step, wherein m is a number of the audio acquisition devices and i=1 . . . m;
wherein a calculation of the orientation is performed by weighting the identification probability and the audio intensity of each of the audio acquisition devices to estimate a direction of a sound source, and comprises any of the following formulas for performing the calculation of the orientation:
$$\begin{matrix}a vector formula : U = \sum ( {P}_{i} \times {L}_{i} \times {u}_{i} ) / \sum ( {P}_{i} \times {L}_{i} ) , and \\ a azimuth formula : θ = \sum ( {P}_{i} \times {L}_{i} \times {θ}_{i} ) / \sum ( {P}_{i} \times {L}_{i} ) ,\end{matrix}$$
U is a unit vector representing an orientation of the abnormal event audio,
θ is an azimuth parameter of the abnormal event audio,
uᵢ is a known geometrical orientation unit vector of an i-th audio acquisition devices,
θᵢ is an known azimuth of the i-th audio acquisition device,
Pᵢ is an identification probability generated by the i-th audio acquisition device after the identification step, and
Lᵢ is an audio intensity received by the i-th audio acquisition device;
wherein a formula for calculating the distance is: R=k×Lₘₐₓ\hat{ }(−½),
R is a parameter of the distance of an abnormal event audio signal, representing a relative distance between the sound source and an audio acquisition device with a highest identification probability,
Lₘₐₓ is the audio intensity obtained by measuring the audio acquisition device with a highest identification probability (Pₘₐₓ),
k is a proportionality constant, representing a sound attenuation coefficient in an environment, and
Lₘₐₓ\hat{ }(−½) represents that the distance is inversely proportional to a square root of the audio intensity.

17. The abnormal event identification system according to claim 13, wherein the main processor further calculates an abnormal event coordinate corresponding to the abnormal location information in a region coordinate map based on the region coordinate map corresponding to locations configured for each of the audio acquisition devices and a camera device, generates a camera adjustment command based on the abnormal event coordinate and a relative position of the camera device in the region coordinate map, and transmits the camera adjustment command to the camera device for the camera device to adjust the shooting view and focus based on the camera adjustment command.

18. An abnormal event warning system, comprising:
a main processor, configured to execute the abnormal event identification method according to claim 1 to generate an abnormal location information; and
at least one warning device, configured in a monitoring region to alert the presence of humans or animals active in the abnormal location information;
wherein the main processor serves as a basis for enabling the at least one warning device located adjacent to the abnormal location information based on a warning device distribution map.
